(19) United States
(12) Patent Application Publication
(10) Pub. No.: US 2024/0175107 A1
(43) Pub. Date: May 30, 2024

(54) COPPER-SILVER-GOLD ALLOY

(71) Applicant: MUNDORF EB GMBH, Köln (DE)

(72) Inventor: Raimund Mundorf, Köln (DE)

(21) Appl. No.: 18/551,240

(22) PCT Filed: Mar. 18, 2022
(86) PCT No.: PCT/EP2022/057257

§ 371 Date: Sep. 19, 2023

(30) Foreign Application Priority Data
Mar. 19, 2021 (DE) 10 2021 106 875.4

(51) Int. Cl. C22C 9/00; H01B 1/02

(52) U.S. Cl. CPC C22C 9/00; H01B 1/026

(57) ABSTRACT

A copper-silver-gold alloy is provided for an electrical, electronic and/or electrotechnical component and/or for a device for sound reproduction and/or recording and/or for sound signal processing, output, reception and/or transmission, in particular for an audio reproduction system. In order to achieve a timbre which is both warm and also has a certain radiant power and elasticity, the alloy includes, relative to the total weight of the alloy, ≥99.70 wt. % to ≤99.98 wt. % copper, ≥0.01 wt. % to ≤0.20 wt. % silver and ≥0.01 wt. % to ≤0.10 wt. % gold.

The invention relates to a copper-silver-gold alloy for an electrical, electronic and/or electrotechnical component and/or for a device for sound reproduction and/or recording and/or for sound signal processing, output, reception and/or transmission. Furthermore, the invention relates to the use of this alloy in an electrical, electronic and/or electrotechnical component and/or device for sound reproduction and/or recording and/or for sound signal processing, output, reception and/or transmission, and also the invention relates to a corresponding electrical, electronic and/or electrotechnical, opponent and/or a corresponding device comprising this alloy. Lastly, the invention relates to an electrical, electronic or electrotechnical part or a corresponding component comprising this alloy.

In devices for sound reproduction and/or recording and/or for sound signal processing, output, reception and/or transmission, as for example for music reproduction, recording and/or processing, for example in speakers, amplifiers, sound signal sources, microphones, sound pickups, for example guitar pickups, mixing desks and also cables and/or components for them, the composition of metals and metal alloys used therein, for example in an electrical, electronic and/or electrotechnical component, may influence the timbre of the sound delivered, received and/or processed via the device.

The prior-art embodiments of metals and alloys, however, are not yet optimal. For instance, through the use of pure copper in electrical, electronic and/or electrotechnical components in such devices, it is indeed possible to achieve a warm timbre, but the timbre achievable as a result has no transparency. Through the use of pure silver in electrical, electronic and/or electrotechnical components in such devices, it is indeed possible to achieve a timbre having a high transparency, and yet the timbre achievable as a result is at the same time also cool.

In some areas of use, for achieving a particular sound impression and/or in the reproduction, recording and/or processing of sound, such as music and/or speech, for example, it may nevertheless be desirable to obtain a timbre having both a great warmth and a certain radiant power and elasticity, this having been so far not adequately possible by means of the metals and alloys known in the prior art, especially in the context of use in an electrical, electronic and/or electrotechnical component for sound reproduction and/or recording and/or for sound signal processing, output, reception and/or transmission, for example for music and/or speech reproduction, recording and/or processing.

An object underlying the invention is therefore the design and development of the aforementioned alloy, the aforementioned use and the aforementioned component or part and/or device in such a way that the alloy enables the attainment of a timbre having both great warmth and a certain radiant power and elasticity in the context of use in an electrical, electronic and/or electrotechnical component or in a corresponding component and/or in a device for sound reproduction and/or recording and/or for sound signal processing, output, reception and/or transmission, for example for music and/or speech reproduction, recording and/or processing.

The object underlying the invention is achieved by the copper-silver-gold alloy having the features of claim 1, by the use having the features of claim 6, and by the corresponding component or part and/or device having the features of claim 9 and of claim 12, respectively.

This copper-silver-gold alloy, based on the total weight of the alloy, comprises
≥90.00 wt % to ≤99.98 wt % copper, as for example ≥99.70 wt % to ≤99.98 wt % copper, for example ≥99.85 wt % to ≤99.95 wt % copper,
≥0.01 wt % to ≤5.00 wt % silver, as for example ≥0.01 wt % to ≤0.20 wt % silver, for example ≥0.04 wt % to ≤0.10 wt % silver, and
≥0.01 wt % to ≤5.00 wt % gold, as for example ≥0.01 wt % to ≤0.10 wt % gold, for example ≥0.01 wt % to ≤0.05 wt % gold.

In particular, the alloy may be geared to or used for an electrical, electronic and/or electrotechnical component for sound reproduction and/or recording and/or for sound signal processing, output, reception and/or transmission, for example for music and/or speech reproduction, recording and/or processing; in particular, the corresponding electrical, electronic and/or electrotechnical component may be produced from this alloy at least partially; more particularly an electrical lead, a conductor track or a connecting element may consist of this alloy. In particular, the alloy is electrically conducting and may therefore itself be employed or used as an electrical component and/or, in particular, as a constituent of an electronic and/or electrotechnical component and/or device.

By means of a composition of this kind for the alloy it is possible advantageously to achieve a timbre which both is warm and possesses a certain radiant power and elasticity, especially in the context of use of the alloy in an electrical, electronic and/or electrotechnical component for sound reproduction and/or recording and/or for sound signal processing, output, reception and/or transmission, for example for music and/or speech reproduction, recording and/or processing.

Wt % may—as is usual in connection with alloys—also be understood in the sense of the invention as, in particular, percent by weight, i.e., a percentage weight fraction or mass fraction, which is based on the total weight of an alloy. A figure in weight percent (wt %) differs in particular from a figure in atomic percent (at %)—likewise used in connection with alloys—which may in particular be understood as a percentage atomic-number fraction, based on the total atomic number of an alloy.

The term “comprise” may be understood in the sense of the invention, in connection with the alloy composition, in particular such that the alloy may contain other elements in addition to the elements stated.

For example, based on the total weight of the alloy, the alloy may be formed of ≥90.00 wt % to ≤99.98 wt % copper, ≥0.01 wt % to ≤5.00 wt % silver and ≥0.01 wt % to ≤5.00 wt % gold, as for example of ≥99.70 wt % to ≤99.98 wt % copper, ≥0.01 wt % to ≤0.20 wt % silver and ≥0.01 wt % to ≤0.10 wt % gold, for example of ≥99.85 wt % to ≤99.95 wt % copper, ≥0.04 wt % to ≤0.10 wt % silver and ≥0.01 wt % to ≤0.05 wt % gold.

The term “formed” in the sense of the invention may be understood in connection with the alloy composition in particular such that the alloy, in addition to the stated elements, may also contain small fractions of other elements, of ≤0.50 wt %, for example, more particularly in each case per other element.

Optionally, based on the total weight of the alloy, the alloy may consist of ≥90.00 wt % to ≤99.98 wt % copper, ≥0.01 wt % to ≤5.00 wt % silver and ≥0.01 wt % to ≤5.00 wt % gold, as for example of ≥99.70 wt % to ≤99.98 wt % copper, ≥0.01 wt % to ≤0.20 wt % silver and ≥0.01 wt % to ≤0.10 wt % gold, for example of ≥99.85 wt % to ≤99.95 wt % copper, ≥0.04 wt % to ≤0.10 wt % silver and ≥0.01 wt % to ≤0.05 wt % gold.

The term “consist” in the sense of the invention may be understood in connection with the alloy composition in particular such that the alloy, in addition to the stated elements, may also contain traces of other elements, in amounts customary in the context of impurities in alloys, for example in the mass-based ppm range, as for example of ≤0.0050 wt %, as for example of ≤0.0040 wt %, for example of ≤0.0030 wt %, more particularly in each case per other element.

Based on the weight of the alloy, the alloy may optionally contain ≥0.01 wt % to 5.00 wt % silver and ≥0.01 wt % to ≤5.00 wt % gold, as for example ≥0.01 wt % to ≤0.20 wt % silver and ≥0.01 wt % to ≤0.10 wt % gold, for example ≥0.04 wt % to ≤0.10 wt % silver and ≥0.01 wt % to ≤0.05 wt % gold, the balance to 100 wt % being formed of copper and impurities, especially unavoidable impurities. These impurities, especially unavoidable impurities, may for example be traces of other elements in amounts typical of alloy impurities, as for example in the mass-based ppm range, for example of <0.0050 wt %, for example of <0.0040 wt %, for example of <0.0030 wt %, in particular in each case per other element.

In terms of copper, the alloy may comprise for example, based on the total weight of the alloy, ≥90.00 wt % or ≥91.00 wt % or ≥92.00 wt % or ≥93.00 wt % or ≥94.00 wt % or ≥95.00 wt % or ≥96.00 wt % or ≥97.00 wt % or ≥98.00 wt %, ≥98.50 wt % or ≥98.80 wt % or ≥99.00 wt % or ≥99.10 wt % or ≥99.20 wt % or ≥99.30 wt % or ≥99.40 wt % or ≥99.50 wt % or ≥99.60 wt % or ≥99.70 wt % or ≥99.71 wt % or ≥99.72 wt % or ≥99.73 wt % or ≥99.74 wt % or ≥99.75 wt % or ≥99.76 wt % or ≥99.77 wt % or ≥99.78 wt % or ≥99.79 wt % or ≥99.80 wt % or ≥99.81 wt % or ≥99.82 wt % or ≥99.83 wt % or ≥99.84 wt % or ≥99.85 wt % to ≤99.98 wt % or ≤99.97 wt % or ≤99.96 wt % or ≤99.95 wt % or ≤99.94 wt % or ≤99.93 wt % or ≤99.92 wt % or ≤99.91 wt % or ≤99.90 wt %.

In terms of silver, the alloy may comprise or contain for example, based on the total weight of the alloy, ≥0.01 wt % or ≥0.02 wt % or ≥0.03 wt % or ≥0.04 wt % or ≥0.05 wt % or ≥0.06 wt % to ≤5.00 wt % or ≤4.00 wt % or ≤3.00 wt % or ≤2.50 wt % or ≤2.00 wt % or ≤1.50 wt % or ≤1.00 wt % or to ≤0.75 wt % or ≤0.50 wt % or ≤0.40 wt % or ≤0.30 wt % or ≤0.20 wt % or ≤0.19 wt % or ≤0.18 wt % or ≤0.17 wt % or ≤0.16 wt % or ≤0.15 wt % or ≤0.14 wt % or ≤0.13 wt % or ≤0.12 wt % or ≤0.11 wt % or ≤0.10 wt % or ≤0.09 wt % or ≤0.08 wt %.

In terms of gold, the alloy may comprise or contain for example, based on the total weight of the alloy, ≥0.01 wt % or ≥0.02 wt % to ≤5.00 wt % or ≤2.00 wt % or ≤1.00 wt % or ≤0.75 wt % or ≤0.50 wt % or ≤0.40 wt % or ≤0.30 wt % or ≤0.20 wt % or ≤0.10 wt % or ≤0.09 wt % or ≤0.08 wt % or ≤0.07 wt % or ≤0.06 wt % or ≤0.05 wt % or ≤0.04 wt %.

For example the alloy, based on the total weight of the alloy, may comprise or contain, for example be formed of, optionally consist of
≥90.00 wt % or ≥91.00 wt % or ≥92.00 wt % or ≥93.00 wt % or ≥94.00 wt % or ≥95.00 wt % or ≥96.00 wt % or ≥97.00 wt % to ≤99.98 wt % or ≤99.97 wt % or ≤99.96 wt % or ≤99.95 wt % copper,
≥0.01 wt % to ≤5.00 wt % or ≤4.00 wt % or ≤3.00 wt % or ≤2.50 wt % or ≤2.00 wt % or ≤1.50 wt % silver,
≥0.01 wt % to ≤5.00 wt % or ≤4.00 wt % or ≤3.00 wt % or ≤2.50 wt % or ≤2.00 wt % or ≤1.5 wt % gold.

In one embodiment, the alloy, based on the total weight of the alloy, comprises or contains
≥98.00 wt %, for example ≥98.50 wt % or ≥99.00 wt % or ≥99.10 wt % or ≥99.20 wt % or ≥99.30 wt % or ≥99.40 wt % or ≥99.50 wt % or ≥99.60 wt %, to ≤99.98 wt %, for example to 99.97 wt % or ≤99.96 wt % or ≤99.95 wt %, copper,
≥0.01 wt % to ≤1.00 wt %, for example to ≤0.75 wt % or ≤0.50 wt % or ≤0.40 wt % or ≤0.30 wt % or ≤0.20 wt %, silver, and
≥0.01 wt % to ≤1.00 wt %, for example to ≤0.75 wt % or ≤0.50 wt % or ≤0.40 wt % or ≤0.30 wt % or ≤0.20 wt %, gold.

A composition of this kind for the alloy has proven advantageous for achieving a warm, radiant and elastic timbre.

Optionally, the alloy in this embodiment, based on the total weight of the alloy, may be formed of or optionally even consist of
≥98.00 wt %, for example ≥98.50 wt % or ≥99.00 wt % or ≥99.10 wt % or ≥99.20 wt % or ≥99.30 wt % or ≥99.40 wt % or ≥99.50 wt % or ≥99.60 wt %, to ≤99.98 wt %, for example to ≤99.97 wt % or ≤99.96 wt % or ≤99.95 wt %, copper,
≥0.01 wt % to ≤1.00 wt %, for example to ≤0.75 wt % or ≤0.50 wt % or ≤0.40 wt % or ≤0.30 wt % or ≤0.20 wt %, silver, and
≥0.01 wt % to ≤1.00 wt %, for example to ≤0.75 wt % or ≤0.50 wt % or ≤0.40 wt % or ≤0.30 wt % or ≤0.20 wt %, gold.

In another embodiment, the alloy, based on the total weight of the alloy, comprises or contains
≥99.70 wt %, for example ≥99.75 wt % or ≥99.80 wt %, to ≤99.98 wt %, to ≤99.97 wt % or ≤99.96 wt % or ≤99.95 wt %, copper,
≥0.01 wt %, for example ≥0.02 wt % or ≥0.03 wt %, to 0.20 wt % silver, and
≥0.01 wt % to ≤0.10 wt %, for example to ≤0.09 wt % or ≤0.08 wt % or ≤0.07 wt % or ≤0.06 wt %, gold.

A composition of this kind for the alloy has proven even more advantageous for achieving a warm, radiant and elastic timbre.

Optionally, the alloy in this embodiment, based on the total weight of the alloy, may be formed of or optionally even consist of
≥99.70 wt %, for example ≥99.75 wt % or ≥99.80 wt %, to ≤99.98 wt %, for example to ≤99.97 wt % or ≤99.96 wt % or ≤99.95 wt %, copper,
≥0.01 wt %, for example ≥0.02 wt % or ≥0.03 wt %, to ≤0.20 wt % silver, and
≥0.01 wt % to ≤0.10 wt %, for example to ≤0.09 wt % or ≤0.08 wt % or ≤0.07 wt % or ≤0.06 wt %, gold.

For example, the alloy, based on the total weight of the alloy, may comprise or contain, for example be formed of, optionally even consist of,
≥99.70 wt %, for example >99.70 wt % or ≥99.71 wt % or ≥99.72 wt % or ≥99.73 wt % or ≥99.74 wt % or ≥99.75 wt % or ≥99.76 wt % or ≥99.77 wt % or ≥99.78 wt % or ≥99.79 wt % or ≥99.80 wt %, for example >99.80 wt % or ≥99.81 wt % or ≥99.82 wt %, to 99.98 wt %, for example to <99.98 wt % or ≤99.97 wt % or ≤99.96 wt % or ≤99.95 wt %, copper, and/or
≥0.01 wt %, for example >0.01 wt % or ≥0.02 wt % or ≥0.03 wt %, to ≤0.20 wt %, for example <0.20 wt %, optionally ≤0.19 wt % or ≤0.18 wt % or ≤0.17 wt % or ≤0.16 wt % or ≤0.15 wt % or ≤0.14 wt % or ≤0.13 wt % or ≤0.12 wt % or ≤0.11 wt % or ≤0.10 wt %, for example to <0.10 wt % or ≤0.09 wt % or ≤0.08 wt %, silver, and/or
≥0.01 wt %, for example >0.01 wt %, optionally ≥0.02 wt %, to ≤0.10 wt %, for example to <0.10 wt % or ≤0.09 wt % or ≤0.08 wt % or ≤0.07 wt % or ≤0.06 wt %, gold.

For example, the alloy, based on the total weight of the alloy, may comprise or contain, for example be formed of, optionally even consist of,
≥99.70 wt %, for example >99.70 wt % or ≥99.71 wt % or ≥99.72 wt % or ≥99.73 wt % or ≥99.74 wt % or ≥99.75 wt % or ≥99.76 wt % or ≥99.77 wt % or ≥99.78 wt % or ≥99.79 wt % or ≥99.80 wt %, for example >99.80 wt % or ≥99.81 wt % or ≥99.82 wt %, to 99.97 wt %, for example to ≤99.97 wt % or ≤99.96 wt % or ≤99.95 wt % copper, and/or
≥0.02 wt %, for example >0.02 wt % or ≥0.03 wt %, to ≤0.20 wt %, for example <0.20 wt %, optionally ≤0.19 wt % or ≤0.18 wt % or ≤0.17 wt % or ≤0.16 wt % or ≤0.15 wt % or ≤0.14 wt % or ≤0.13 wt % or ≤0.12 wt % or ≤0.11 wt % or ≤0.10 wt %, for example to <0.10 wt % or ≤0.09 wt % or ≤0.08 wt %, silver, and/or
≥0.01 wt %, for example >0.01 wt %, optionally ≥0.02 wt %, to 0.10 wt %, for example to <0.10 wt % or ≤0.09 wt % or ≤0.08 wt % or ≤0.07 wt % or ≤0.06 wt %, gold.

For example, the alloy, based on the total weight of the alloy, may comprise or contain, for example be formed of, optionally even consist of,
≥99.80 wt %, for example >99.80 wt %, optionally ≥99.81 wt % or ≥99.82 wt %, to 99.97 wt %, optionally to <99.97 wt % or ≤99.96 wt % or ≤99.95 wt %, copper, and/or
≥0.02 wt %, optionally >0.02 wt % or ≥0.03 wt %, to ≤0.10 wt %, for example to <0.10 wt %, optionally ≤0.09 wt % or ≤0.08 wt %, silver, and/or
≥0.01 wt %, for example >0.01 wt %, optionally ≥0.02 wt %, to ≤0.10 wt %, for example to <0.10 wt %, optionally to ≤0.09 wt % or ≤0.08 wt % or ≤0.07 wt % or ≤0.06 wt %, gold.

In another preferred embodiment, the alloy, based on the total weight of the alloy, comprises
≥99.85 wt %, for example >99.85 wt %, to ≤99.95 wt %, for example to ≤99.94 wt % or ≤99.93 wt % or 99.92 wt % or ≤99.91 wt % or ≤99.90 wt %, copper,
≥0.04 wt %, for example ≥0.05 wt % or ≥0.06 wt %, to 0.10 wt %, for example to <0.10 wt % or ≤0.09 wt % or ≤0.08 wt %, silver, and
≥0.01 wt %, for example ≥0.02 wt %, to ≤0.05 wt %, for example to ≤0.04 wt %, gold.

A composition of this kind for the alloy has proven particularly advantageous for achieving a warm, radiant and elastic timbre, in particular with swing.

Optionally, the alloy in this embodiment, based on the total weight of the alloy, may be formed of or optionally even consist of
≥99.85 wt %, for example >99.85 wt %, to ≤99.95 wt %, for example to 99.94 wt % or ≤99.93 wt % or ≤99.92 wt % or ≤99.91 wt % or ≤99.90 wt %, copper,
≥0.04 wt %, for example ≥0.05 wt % or ≥0.06 wt %, to ≤0.10 wt %, for example to <0.10 wt % or ≤0.09 wt % or ≤0.08 wt %, silver, and
≥0.01 wt %, for example ≥0.02 wt %, to ≤0.05 wt %, for example to ≤0.04 wt %, gold.

For example, the alloy may comprise or be formed of, or optionally consist of, 99.90 wt % copper, 0.07 wt % silver and 0.03 wt % gold.

In a further embodiment, the mass fraction of silver is higher than the mass fraction of gold.

This has proven advantageous for achieving a warm, radiant and elastic timbre.

In a further embodiment, the mass fraction of silver is twice the mass fraction of gold.

This has proved particularly advantageous for achieving a warm, radiant and elastic timbre.

In a further embodiment, the sum of the mass fraction of silver and the mass fraction of gold, based on the total weight of the alloy, is ≤1.00 wt %, as for example ≤0.50 wt %, for example ≤0.20 wt %, as for example ≤0.15 wt %. For example, the sum of the mass fraction of silver and the mass fraction of gold, based on the total weight of the alloy, may be ≥0.02 wt % to ≤1.00 wt %, especially ≥0.02 wt % to ≤0.50 wt %, as for example ≥0.02 wt % to ≤0.30 wt % or ≤0.20 wt %, for example ≥0.05 wt % to ≤0.15 wt %.

In this way, advantageously, the breadth of the timbre can be enlarged and has likewise proven particularly advantageous for achieving a warm, radiant and elastic timbre.

For further advantages and further technical features of the alloy of the invention, reference is made to the elucidations in connection with the use, component and/or device of the invention and/or with the part of the invention, and also to the description of the figures and the tonal analysis.

A further subject is the use of an alloy of the invention in an electrical, electronic and/or electrotechnical component and/or in a device for sound reproduction and/or recording and/or for sound signal processing, output, reception and/or transmission, for example for music and/or speech reproduction, recording and/or processing, especially in an audio reproduction system.

In one embodiment thereof, the electrical, electronic and/or electrotechnical component is an inductive electronic component, especially a coil, especially a moving coil or a choke coil, and/or a capacitive electronic component, especially a capacitor, and/or a printed circuit board (PCB) and/or a filter, especially a crossover filter, for example a printed circuit board of a crossover filter, and/or an ohmic resistor and/or a switch and/or a transformer, for example an audio and/or voltage transformer, and/or a solder and/or an electrical lead, especially interior cabling or exterior cabling or a cable, especially a speaker cable and/or a mains cable, or a conductor track of a printed circuit board and/or a wire and/or a connecting element, for example for connecting a coil and/or a capacitor, and/or for connecting a printed circuit board and/or a filter, such as a crossover filter, and/or for connecting an ohmic resistor and/or a switch, and/or for connecting a transformer, for example an audio and/or voltage transformer, and/or for connecting a speaker and/or for connecting an amplifier and/or a sound signal source and/or a microphone and/or a sound pickup, especially for an instrument, for example for a guitar, and/or for connecting a mixing desk, for example a terminal, for example a speaker terminal and/or an amplifier terminal, and/or an electrical terminal and/or a plug and/or a socket and/or a strand and/or a lug.

In another embodiment thereof, the electrical, electronic and/or electrotechnical component is a component of a speaker and/or of an amplifier and/or of a sound signal source and/or of a microphone and/or of a sound pickup, especially for an instrument, for example for a guitar, and/or of a mixing desk, and/or the electrical, electronic and/or electrotechnical device is a speaker and/or an amplifier and/or a sound signal source and/or a microphone and/or a sound pickup, especially for an instrument, for example for a guitar, and/or a mixing desk.

For the advantages and further technical features of the use according to the invention, reference is made to the elucidations in connection with the alloy, component and/or device of the invention and/or with the part of the invention, and also to the description of the figures and the tonal analysis.

Furthermore, the invention relates to an electrical, electronic and/or electrotechnical component and/or device for sound reproduction and/or recording and/or for sound signal processing, output, reception and/or transmission, for example for music and/or speech reproduction, recording and/or processing, comprising an alloy of the invention, especially to an audio reproduction system.

In one embodiment thereof, the electrical, electronic and/or electrotechnical component is an inductive electronic component, especially a coil, especially a moving coil or a choke coil, and/or a capacitive electronic component, especially a capacitor, and/or a printed circuit board (PCB) and/or a filter, especially a crossover filter, for example a printed circuit board of a crossover filter, and/or an ohmic resistor and/or a switch and/or a transformer, for example an audio and/or voltage transformer, and/or a solder and/or an electrical lead, especially interior cabling or exterior cabling or a cable, especially a speaker cable and/or a mains cable, or a conductor track of a printed circuit board and/or a wire and/or a connecting element, for example for connecting a coil and/or a capacitor, and/or for connecting a printed circuit board and/or a filter, such as a crossover filter, and/or for connecting an ohmic resistor and/or a switch, and/or for connecting a transformer, for example an audio and/or voltage transformer, and/or for connecting a speaker and/or for connecting an amplifier and/or a sound signal source and/or a microphone and/or a sound pickup, especially for an instrument, for example for a guitar, and/or for connecting a mixing desk, for example a terminal, for example a speaker terminal and/or an amplifier terminal, and/or an electrical terminal and/or a plug and/or a socket and/or a strand and/or a lug.

In another embodiment thereof, the electrical, electronic and/or electrotechnical opponent is a component of a speaker, and/or of an amplifier and/or of a sound signal source and/or of a microphone and/or of a sound pickup, especially for an instrument, for example a guitar, and/or of a mixing desk, and/or
the electrical, electronic and/or electrotechnical device is a speaker, and/or an amplifier and/or a sound signal source and/or a microphone and/or a sound pickup, especially for an instrument, for example for a guitar, and/or a mixing desk.

For the advantages and further technical features of the components and/or device of the invention, reference is made to the elucidations in connection with the alloy and use according to the invention and/or with the part of the invention, and also to the description of the figures and the tonal analysis.

The invention further relates to an electrical, electronic and/or electrotechnical part and/or an electrical, electronic and/or electrotechnical component, especially for an audio reproduction system and/or especially as part of an audio reproduction system, comprising a copper-silver-gold alloy of the invention.

In one embodiment thereof, the part and/or the component is embodied and/or configured as a capacitor, as a transistor or as a resistor or as a coil, especially as a choke coil or moving coil.

In a further embodiment thereof, a connecting element and/or a connecting wire and/or a connection point of the part and/or component, especially of the capacitor, the transistor, the resistor or the coil, especially of a choke coil or a moving coil, is produced from a copper-silver-gold alloy of the invention.

In a further embodiment thereof, the part and/or the component is configured as a capacitor. This capacitor may comprise in particular at least one carrier element and/or at least one insulator element, especially a polymeric foil or a paper foil. Here, the carrier element and/or the insulator element may be in particular metallized, especially comprising the aforesaid copper-silver-gold alloy of the invention as metallized layer.

In a further preferred embodiment, the part and/or the component are/is configured as a coil, especially as a moving coil or a choke coil, and/or as a crossover filter. In a further especially preferred embodiment, the part and/or the component are/is configured as a choke coil and installed in a crossover filter.

For the advantages and further technical features of the part components of the invention and/or of the component of the invention, reference is made to the elucidations in connection with the alloy, use and device according to the invention, and also to the description of the figures and the timbre analysis.

So there are a multiplicity of possibilities for designing and developing the alloy of the invention, the use according to the invention and the component of the invention, or the part and/or device of the invention, in an advantageous manner. For this purpose, reference may be made first to the claims subordinate to claims 1, 6, 9 and 12. Elucidated in more detail below are preferred embodiments, with reference to the drawing and the associated description and also with reference to the results of timbre analyses on different metals and metal alloys. In the drawing:

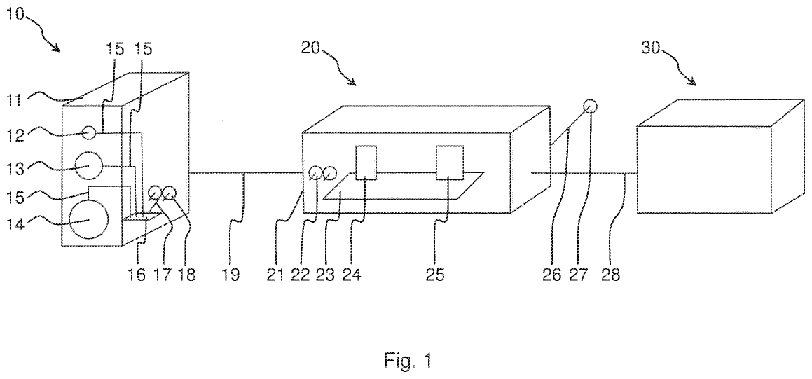

FIG. 1 in a schematic representation shows a sound reproduction system or audio reproduction system with a speaker, an amplifier and a sound signal source, and illustrates a multiplicity of possible uses of the alloy of the invention according to a multiplicity of different, possible embodiments of a respective component and/or device of the invention.

FIG. 1 shows an audio reproduction system with a speaker 10, an amplifier 20 and a sound signal source 30, where, in a multiplicity of possible uses, it is possible to use a copper-silver-gold alloy which—based on the total weight of the alloy—comprises ≥90.00 wt % to ≤99.98 wt % copper, ≥0.01 wt % to ≤5.00 wt % silver and ≥0.01 wt % to ≤5.00 wt % gold, as for example of ≥99.70 wt % to 99.98 wt % copper, ≥0.01 wt % to ≤0.20 wt % silver and ≥0.01 wt % to ≤0.10 wt % gold, for example of ≥99.85 wt % to ≤99.95 wt % copper, ≥0.04 wt % to ≤0.10 wt % silver and ≥0.01 wt % to ≤0.05 wt % gold.

FIG. 1 illustrates the speaker 10 as having a speaker housing 11. Mounted in the speaker housing 11 are, in particular, three speaker chassis with three moving coils 12, 13 and 14.

The three aforesaid moving coils 12, 13 and 14 each in particular have at least one electrical conductor, of which at least one electrical conductor may be formed of the alloy of the invention. For example, the copper-silver-gold alloy may be embodied in the form of a moving coil wire, having a diameter for example of about ≥0.1 mm to ≤2 mm.

FIG. 1 also shows that the moving coils 12, 13 and 14 are connected via a respective electrical lead, particularly by respective internal cabling, as for example via moving coil-crossover filter cabling 15, to a crossover filter 16, with the crossover filter 16 being connected in turn via a further lead or cabling, more particularly interior cabling, as for example via crossover filter-speaker terminal cabling 17, to a speaker terminal 18 or a connection socket. Here, the respective moving coil-crossover filter cabling 15 and/or the crossover filter 16 and/or the crossover filter-speaker terminal cabling 17 and/or the speaker terminal 18, or the respective electrical lead, the respective electrical conductor and/or the respective conductor track, may feature and/or comprise the copper-silver-gold alloy. The respective moving coil-crossover filter cabling 15 and/or the crossover filter-speaker terminal cabling 17 may have a diameter for example of about ≥0.2 mm to ≤3 mm.

As is readily apparent from FIG. 1, for an audio reproduction system, a wide variety of different electrical, electronic and/or electrotechnical components, especially those represented at least partially here, in the audio reproduction system represented in FIG. 1, may individually, by themselves, or else multiply, in isolation or else all, comprise the alloy of the invention. In particular, at least one electrical lead and/or an electrical lead of at least one of the components of the audio reproduction system represented in FIG. 1 is made of the alloy of the invention or comprises this alloy. It may be pointed out that FIG. 1 shows a highly simplified, schematic view of an audio reproduction system, where not all the electrical, electronic and/or electrotechnical opponents are represented in every detail, but at least some of them are represented in a respective simplified schematic representation. In this context, the electrical, electronic and/or electrotechnical components can also be referred to as electrical, electronic and/or electrotechnical “parts”.

In the crossover filter 16, the copper-silver-gold alloy may be used, for example, as conducting material, for example in the form of a foil, having a thickness of ≥20 μm to ≤200 μm, for example, in the form of conductor tracks of a conductor plate and/or for metallization, of a polymeric foil and/or of a paper and/or of a different insulator, for example. Also conceivable and possible is the use of the alloy of the invention in a capacitor and/or as metal foil, with a thickness, for example, of ≥4 μm to ≤20 μm and/or a width of ≥5 mm to ≤100 mm, in a capacitor, and/or else as a wire—round or angular, for example—of a coil, having a diameter or cross section, respectively, of ≥0.4 mm to ≤5 mm, for example, and/or as a foil coil, having a thickness of ≥10 μm to ≤100 μm and/or a width of ≥5 mm to ≤200 mm, for example, and/or as an electrical conductor, and/or as an addition to an electrical conductor in an ohmic resistor, for example a wire or film/foil resistor, and/or as solder.

As the above observations show, corresponding electrical, electronic and/or electrotechnical components, especially the electrical conductors and/or electrical leads of at least one of the components of the audio reproduction system represented in FIG. 1, can comprise the alloy of the invention; in particular, the respective electrical conductor and the respective electrical leads are produced from or made of the alloy of the invention. However, other possible uses also exist or are possible for the alloy of the invention—for example, as solder, connecting element, electrical terminal, lug, seat or the like.

For example, the copper-silver-gold alloy may also be used to form one or more solder points and/or connection elements, for example strands, lugs and/or electrical terminals and/or sockets, as for example for connecting the moving coil or coils 12, 13 and 14 and/or the respective moving coil-crossover filter cabling 15 and/or the crossover filter 16 and/or the crossover filter-speaker terminal cabling 17 and/or the speaker terminal 18, and/or switches (not represented in FIG. 1).

FIG. 1 also shows that a speaker cable 19 is connected to the speaker terminal 18 on the outside of the speaker housing 11, with the speaker cable 19 connecting the speaker 10 to an amplifier 20 or to the output stage of an amplifier 20. FIG. 1 shows that, here, the speaker cable 19 is connected to an amplifier terminal 22 which is accessible from the outside of an amplifier housing 21. The speaker cable 19 and/or the amplifier terminal 22 may also, for example, comprise or feature the copper-silver-gold alloy; in particular, the electrical lead of the respective cabling may feature the alloy of the invention.

FIG. 1 additionally shows that the amplifier 20 further comprises a conductor plate 23 and, for example, two further elements 24 and 25, and can be connected to the mains power via a mains cable 26 with a mains cable plug 27. The conductor plate 23 and/or the elements 24 and 25 and/or the mains cable 26 and/or the mains cable plug 27 of the amplifier 20 may also comprise, for example, the copper-silver-gold alloy. The elements 24 and 25 may be embodied, for example, as capacitors. Also conceivable is the corresponding embodiment and/or arrangement of transformers and/or of resistors, according to the specific embodiment of the amplifier 20. These aforementioned elements and components may also feature the alloy of the invention.

The sound signal source 30 represented in FIG. 1 may be, for example, a CD player, a streamer, an audio converter, especially a DAC, for example for a computer (PC), a smartphone or a mixing desk, and may, for example, likewise comprise the copper-silver-gold alloy.

The amplifier 20 may be connected via a signal source cable 28, for example a LF cable (LF=low frequency) or wirelessly to the sound signal source 30. This signal source cable 28 may likewise comprise or feature the copper-silver-gold alloy. In the respective components represented in FIG. 1, here for example the cables 15, 17, 19, 26 and 28, the copper-silver-gold alloy may feature as conductor, for example, and/or may be used as plug contact material and/or as solder for their connection.

In the amplifier 20 and the sound signal source 30, the copper-silver-gold alloy—in analogy to the explanations in connection with the description of the speaker 10—may be used in capacitors and/or coils, especially in choke coils or moving coils, and/or in resistors and/or switches and/or conductor plates and/or connection elements, such as plugs and/or sockets.

Moreover, the copper-silver-gold alloy may be used, for example, as wire in audio transformers and voltage transformers, with a diameter for example of ≥0.2 mm to ≤4 mm, and/or in microphones and/or sound pickups, especially for instruments, as for example for guitars, with a diameter for example of ≥0.01 mm to ≤0.2 mm.

### Timbre Analyses

For the analysis of the timbre of different metals and metal alloys, coils, especially moving coils and/or choke coils, were produced from the metals or metal alloys under investigation, and were installed one after another in a speaker. The timbres produced by the speaker were then ascertained.

TABLE 1
Comparative experiments by means of timbre analysis
of a speaker equipped with different moving coils and/or
choke coils of copper, silver and alloys thereof

| | Copper | Silver | Gold | |
|---|---|---|---|---|
| Number | [wt %] | [wt %] | [wt %] | Timbre |
| 1 (CE) | 100 | | | warm, |
| | | | | intimate |
| 2 (CE) | | 100 | | cool, |
| | | | | transparent |
| 3 (CE) | 99.9 | 0.1 | | close, |
| | | | | throaty |
| 4 (IE) | 99.9 | 0.07 | 0.03 | warm, |
| | | | | radiant, |
| | | | | elastic |
| | | | | (swing) |
| 5 (IE) | 99.98 | 0.01 | 0.01 | warm, |
| | | | | somewhat |
| | | | | radiant & |
| | | | | elastic |
| 6 (IE) | 99.97 | 0.02 | 0.01 | warm, |
| | | | | radiant, |
| | | | | elastic |
| 7 (IE) | 99.95 | 0.04 | 0.01 | warm, |
| | | | | radiant, |
| | | | | elastic |
| | | | | (swing) |
| 8 (IE) | 99.85 | 0.10 | 0.05 | warm, |
| | | | | radiant, |
| | | | | elastic |
| | | | | (swing) |
| 9 (IE) | 99.70 | 0.20 | 0.10 | warm, |
| | | | | radiant, |
| | | | | elastic |
| 10 (CE) | 99.90 | 0 | 0.10 | warm |

Carried out for the timbre analysis were a first experimental series based on moving coils according to table 1, a second experimental series based on choke coils according to table 1, and a third experimental series based on a combination of a moving coil and a choke coil made from materials of the same kind according to table 1.

The coils made from the metals or alloys numbered 1 to 3 and 10 represent comparative examples (CE). The coils made from the alloys numbered 4 to 9 are formed of different embodiments of the copper-silver-gold alloy of the invention and so constitute inventive examples (IE).

Table 1 shows that the moving coil and/or choke coil number 1 made of copper gave a warm and intimate timbre, whereas the moving coil and/or choke coil number 2 made of silver gave a cool and transparent timbre.

The moving coil and/or choke coil number 3 made of a copper-silver alloy composed of 99.9 wt % copper and 0.1 wt % silver gave a close, throaty timbre. The moving coil and/or choke coil number 10 made of a copper-gold alloy composed of 99.90 wt % copper and 0.10 wt % gold gave a warm timbre.

Table 1 shows that the moving coil and/or choke coil number 4 made of a copper-silver-gold alloy composed of 99.9 wt % copper, 0.07 wt % silver and 0.03 wt % gold, which serves in particular as an inventive exemplary embodiment, surprisingly gave a warm, radiant and elastic timbre with “swing”.

Table 1 also shows that the inventive examples (IE) numbers 5 to 9, of which example (IE) number 5 is based on a copper-silver-gold alloy composed of 99.98 wt % copper, 0.01 wt % silver and 0.01 wt % gold, example (IE) number 6 is based on a copper-silver-gold alloy composed of 99.97 wt % copper, 0.02 wt % silver and 0.01 wt % gold, example (IE) number 7 is based on a copper-silver-gold alloy composed of 99.95 wt % copper, 0.04 wt % silver and 0.01 wt % gold, example (IE) number 8 is based on a copper-silver-gold alloy composed of 99.85 wt % copper, 0.10 wt % silver and 0.05 wt % gold, and example (IE) number 9 is based on a copper-silver-gold alloy composed of 99.70 wt % copper, 0.20 wt % silver and 0.10 wt % gold, likewise give an advantageous, warm, radiant and elastic timbre. By means of copper-silver-gold alloys composed of ≥99.70 wt % to ≤99.98 wt % copper, ≥0.01 wt % to ≤0.20 wt % silver, and ≥0.01 wt % to ≤0.10 wt % gold, based on the total weight of the alloy, it is therefore possible advantageously to achieve a warm, radiant and elastic timbre. Here, a higher mass fraction of silver than of gold, as for example a mass fraction of silver at least twice that of gold, appears to be advantageous for the strength of the timbre, especially the strength of the radiant force and elasticity.

Table 1 shows in particular that the inventive examples (IE) numbers 4, 7 and 8, of which example number 4 is based on a copper-silver-gold alloy composed of 99.90 wt % copper, 0.07 wt % silver and 0.03 wt % gold, example (IE) number 7 is based on a copper-silver-gold alloy composed of 99.95 wt % copper, 0.04 wt % silver and 0.01 wt % gold, and example (IE) number 8 is based on a copper-silver-gold alloy composed of 99.85 wt % copper, 0.10 wt % silver and 0.05 wt % gold, give a particularly advantageous, warm, radiant and elastic timbre with “swing”. By means of copper-silver-gold alloys composed of ≥99.85 wt % to ≤99.95 wt % copper, ≥0.04 wt % to ≤0.10 wt % silver, and ≥0.01 wt % to ≤0.05 wt % gold, based on the total weight of the alloy, it is therefore possible to achieve an especially advantageous, warm, radiant and elastic timbre with “swing”.

From a comparison of the timbres of comparative examples (CE) number 1 to 3 and 10 and of inventive examples (IE) number 4 to 9, it is apparent that the comparative examples (CE) lack radiant force and also elasticity and, in particular, lack swing as well. In light of this, the advantageous warm, radiant and elastic timbre, in particular with swing, of the inventive examples appears to be based on their copper-silver-gold alloys in the specific ranges.

Furthermore, the inventive examples number 4 to 9, especially examples (IE) numbers 4, 7 and 8, show that the alloys of the invention are suitable with particular advantage for forming coils, for example choke coils and/or moving coils, especially choke coils.

From the observations above it is evident that different/various electrical, electronic and/or electrotechnical parts and/or electrical, electronic and/electrotechnical components can comprise the above-stated copper-silver-gold alloy. Contemplated here in particular are capacitors, transistors, resistors or coils, especially choke coils or moving coils. In these cases, in particular, the connection points/connecting wires of these parts and/or components may be embodied in the above-stated alloy or be produced of/from this above-stated alloy. Especially in the case of a capacitor, where, for example, the capacitor has a carrier element and/or an insulator element, such as a polymeric foil or a paper foil, for example, the carrier element or insulator element is then provided, in particular at least on one side, with the above-stated copper-silver-gold alloy, being more particularly metallized correspondingly with the above-stated copper-silver-gold alloy. In this case, in particular, a corresponding layer of the copper-silver-gold alloy in the alloy composition referred to above has then been applied by vapor deposition to the carrier element or insulator element of the capacitor.

### LIST OF REFERENCE SIGNS

10 speaker
11 speaker housing
12 moving coil
13 moving coil
14 moving coil
15 moving coil-crossover filter cabling
16 crossover filter
17 crossover filter-speaker terminal cabling
18 speaker terminal
19 speaker cable
20 amplifier/amplifier output stage
21 amplifier housing
22 amplifier terminal
23 circuit board
24 element
25 element
26 mains cable
27 mains cable plug
28 signal source cable
30 sound signal source

1-17. (canceled)

18. A copper-silver-gold alloy for at least one of an electrical, electronic or electrotechnical component for at least one of sound reproduction or recording or for sound signal processing, output, reception or transmission, or for music or speech reproduction, recording or processing or for an audio reproduction system, the alloy, based on a total weight of the alloy, comprising:
≥99.70 wt % to ≤99.98 wt % copper,
≥0.01 wt % to ≤0.20 wt % silver, and
≥0.01 wt % to ≤0.10 wt % gold.

19. The alloy according to claim 18, wherein the alloy, based on the total weight of the alloy, comprises:
≥99.85 wt % to ≤99.95 wt % copper,
≥0.04 wt % to ≤0.10 wt % silver, and
≥0.01 wt % to ≤0.05 wt % gold.

20. The alloy according to claim 18, wherein a mass fraction of the silver is higher than a mass fraction of the gold.

21. The alloy according to claim 18, wherein a mass fraction of the silver is at least twice a mass fraction of the gold.

22. The alloy according to claim 18, wherein, based on the total weight of the alloy, a sum of a mass fraction of the silver and a mass fraction of the gold is ≤0.20 wt %.

23. The alloy according to claim 18, wherein, based on the total weight of the alloy, a sum of a mass fraction of the silver and a mass fraction of the gold is ≤0.15 wt %.

24. A method of using an alloy, the method comprising:
using the alloy according to claim 18 in at least one of an electrical, electronic or electrotechnical component or in a device for sound reproduction or recording or for sound signal processing, output, reception or transmission, or for music or speech reproduction, recording or processing, or in an audio reproduction system.

25. The method according to claim 24, which further comprises providing the at least one of electrical, electronic or electrotechnical component as an inductive electronic component, or a coil, or a moving coil or a choke coil, or a capacitive electronic component, or a capacitor, or a printed circuit board or a filter, or a crossover filter, or a printed circuit board of a crossover filter, or an ohmic resistor or a switch or a transformer, or an audio or voltage transformer, or a solder or an electrical lead, or interior cabling or exterior cabling or a cable, or a speaker cable or a mains cable or a conductor track of a printed circuit board or a wire or a connecting element, or for connecting a coil or a capacitor, or for connecting a printed circuit board or a filter, or a crossover filter, or for connecting an ohmic resistor or a switch, or for connecting a transformer, or an audio or voltage transformer, or for connecting a speaker, or for connecting an amplifier or a sound signal source, or for connecting a microphone or a sound pickup, or for an instrument, or for a guitar, or for connecting a mixing desk, or a terminal, or a speaker terminal or an amplifier terminal, or an electrical terminal or a plug or a socket or a strand or a lug.

26. The method according to claim 24, which further comprises providing the at least one of electrical, electronic or electrotechnical component as a component of a speaker or of an amplifier or of a sound signal source or of a microphone or of a sound pickup, or for an instrument, or for a guitar, or of a mixing desk, or providing the at least one of electrical, electronic or electrotechnical device as a speaker, or an amplifier or a sound signal source or a microphone or a sound pickup, or for an instrument, or for a guitar, or a mixing desk.

27. An at least one of electrical, electronic or electrotechnical component or device, for at least one of sound reproduction or recording or for sound signal processing, output, reception or transmission, or for music or speech reproduction, recording or processing, or audio reproduction system, comprising an alloy according to claim 18.

28. The at least one of electrical, electronic or electrotechnical component or device according to claim 27, wherein the at least one of electrical, electronic or electrotechnical component is an inductive electronic component, or a coil, or a moving coil or a choke coil, or a capacitive electronic component, or a capacitor, or a printed circuit board or a filter, or a crossover filter, or a printed circuit board of a crossover filter, or an ohmic resistor or a switch or a transformer, or an audio or voltage transformer, or a solder or an electrical lead, or interior cabling or exterior cabling or a cable, or a speaker cable or a mains cable or a conductor track of a printed circuit board or a wire or a connecting element, or for connecting a coil or a capacitor, or for connecting a printed circuit board or a filter, or a crossover filter, or for connecting an ohmic resistor or a switch, or for connecting a transformer, or an audio or voltage transformer, or for connecting a speaker, or for connecting an amplifier or a sound signal source, or for connecting a microphone or a sound pickup, or for an instrument, or for a guitar, or for connecting a mixing desk, or a terminal, or a speaker terminal or an amplifier terminal, or an electrical terminal or a plug or a socket or a strand or a lug.

29. The at least one of electrical, electronic or electrotechnical component or device according to claim 27, wherein the at least one of electrical, electronic or electrotechnical component is a component of a speaker, or of an amplifier or of a sound signal source or of a microphone or of a sound pickup, or for an instrument, or for a guitar, or of a mixing desk, or the at least one of electrical, electronic or electrotechnical device is a speaker, or an amplifier or a sound signal source or a microphone or a sound pickup, or for an instrument, or for a guitar, or a mixing desk.

30. An at least one of electrical, electronic or electrotechnical part or at least one of an electrical, electronic or electrotechnical component, for at least one of an audio reproduction system or as part of an audio reproduction system, comprising the copper-silver-gold alloy according to claim 18.

31. The part or component according to claim 30, wherein the part or component is embodied or configured as a capacitor, as a transistor, as a resistor, as a coil, or as a choke coil or a moving coil.

32. The part or component according to claim 30, wherein a connecting element or a connecting wire or a connection point of the part or component, or of the capacitor, or the transistor, or the resistor or the coil, is produced from the copper-silver-gold alloy.

33. The part or component according to claim 30, wherein the part or component is configured as a capacitor, the capacitor includes at least one carrier element or at least one insulator element, or a polymeric foil or a paper foil, and the carrier element or the insulator element is metallized or includes the copper-silver-gold alloy as a metallized layer.

34. The part or component according to claim 30, wherein the part or component is configured as a coil, or as a moving coil or a choke coil, or as a crossover filter.

35. The part or component according to claim 34, wherein the part or component is configured as a choke coil and is installed in a crossover filter.
